(19) United States
(12) Patent Application Publication
(10) Pub. No.: US 2026/0148378 A1
(43) Pub. Date: May 28, 2026

(54) METHOD FOR SETTING POSITION OF CROWN BY TEETH SHAPE SEGMENTATION

(71) Applicant: Huvitz Co., Ltd., Anyang-si (KR)

(72) Inventors: Jun Ho PARK, Anyang-si (KR); Kwang Young JUNG, Anyang-si (KR); Weon Joon LEE, Anyang-si (KR)

(21) Appl. No.: 19/376,685

(22) Filed: Oct. 31, 2025

(30) Foreign Application Priority Data
Nov. 22, 2024 (KR) 10-2024-0168347

(51) Int. Cl. G06T 7/00; A61C 8/00; A61C 13/00; G06T 7/11

(52) U.S. Cl. CPC G06T 7/0012; A61C 8/00; A61C 13/0004; G06T 7/11; G06T 2207/20081; G06T 2207/20084; G06T 2207/30036

(57) ABSTRACT

A method for setting the position of a crown using teeth shape segmentation includes the steps of: analyzing a teeth shape image including a crown region where a tooth has been prepared, to segment an overall teeth shape into individual tooth regions; selecting, from the segmented individual tooth regions, a mesial tooth and a distal tooth respectively positioned anterior and posterior to the crown region where a working tooth is to be positioned; calculating a position where the working tooth is to be placed based on positions of the mesial tooth and the distal tooth; and positioning the working tooth in the crown region of the teeth shape image according to the calculated position where the working tooth is to be placed.

### CROSS-REFERENCE TO RELATED APPLICATION

This application claims benefit of priority to Korean Patent Application No. 10-2024-0168347 filed on Nov. 22, 2024, the entire contents of which are incorporated herein by reference.

### TECHNICAL FIELD

The present invention relates to setting the position of a crown for treating damaged a tooth, and more particularly, to a method for setting the position of a crown by teeth shape segmentation.

### BACKGROUND

Prosthetic treatment is a dental treatment that removes damaged portions of teeth and restores tooth function by mounting a prosthesis in the area where the damaged portion has been removed. Types of dental prosthetics include a crown that covers tooth, a bridge that connects artificial teeth, a resin that fills grinded damaged portions of teeth, inlays, onlays, and the like. FIG. 1 is a diagram illustrating a conventional crown prosthetic treatment process. As shown in FIG. 1, in a conventional crown prosthetic treatment, when damage such as a cavity (2) occurs in a tooth (1) (see FIG. 1A), the damaged portion is removed along a tooth preparation line (4) to form a tooth preparation area, i.e., a “crown region” (see FIG. 1B), and a crown (6), which is an artificial dental prosthesis manufactured according to the patient's tooth shape, is attached to the tooth preparation area to restore tooth function (see FIG. 1C). In FIG. 1, reference numeral 8 denotes the gum (gingiva).

In such crown prosthetic treatment, a crown (6) having a shape and size suitable for the patient's overall tooth shape must be manufactured. To manufacture a crown (6) suitable for the patient's tooth shape, first, a maxillary arch or mandibular arch model (i.e., a maxillary or mandibular shape image) corresponding to the patient's overall tooth shape is obtained using an oral scanner or the like, and a standard crown template (commonly referred to as a “working tooth”) is positioned in the tooth preparation area of the maxillary or mandibular model displayed on a monitor. Next, considering the patient's overall tooth shape, the shape and size of the standard crown template are modified to obtain shape data of the crown (6) suitable for the patient's tooth shape. This operation is referred to as CAD (computer-aided design) work. When an actual crown (6) is manufactured according to the crown shape data obtained in this way, the manufactured crown (6) has a shape and size suitable for the patient's overall tooth shape.

Typically, to properly position the standard crown template in the tooth preparation area of the maxillary or mandibular model, a user identifies the position of the tooth preparation area in the maxillary or mandibular model displayed on the monitor, and moves and rotates the image of the standard crown template to position it at a predetermined tooth position, i.e., the tooth preparation area. Such a process of setting the position of the standard crown template is time-consuming, and unskilled operators may incorrectly set the initial position of the standard crown template.

Meanwhile, in the applicant's Korean patent application No. 10-2023-0153010, a method is disclosed in which adjacent teeth neighboring the area where the standard crown template is to be positioned are selected, and the center coordinates of the area where the standard crown template is to be positioned are calculated from the margin line of the area where the standard crown template is to be positioned, thereby setting the position of the standard crown template.

### PRIOR ART DOCUMENTS

(Patent Document 1) Korean Patent No. 10-2453932

(Patent Document 2) Korean Patent Application No. 10 -2023-0153010

### SUMMARY

An object of the present invention is to provide a crown position setting method capable of automatically positioning a standard crown template in a tooth preparation area of a maxillary or mandibular model.

Another object of the present invention is to provide a crown position setting method capable of improving the convenience of CAD work for obtaining crown shape data suitable for a patient's tooth shape by modifying a standard crown template.

To achieve the above objects, the present invention provides a crown position setting method comprising the steps of: analyzing a teeth shape image (50) including a crown region where a tooth has been prepared, to segment an overall teeth shape into individual tooth regions; selecting, from the segmented individual tooth regions, a mesial tooth (62) and a distal tooth (64) respectively positioned anterior and posterior to the crown region where a working tooth (80) is to be positioned; calculating a position where the working tooth (80) is to be placed based on positions of the mesial tooth (62) and the distal tooth (64); and positioning the working tooth (80) in the crown region of the teeth shape image (50) according to the calculated position where the working tooth (80) is to be placed.

According to the crown position setting method of the present invention, by automatically positioning the standard crown template in the tooth preparation area of the maxillary or mandibular model, the convenience of CAD work for obtaining crown shape data suitable for the patient's tooth shape by modifying the standard crown template can be improved.

### BRIEF DESCRIPTION OF THE DRAWINGS

FIG. 1 is a diagram illustrating a conventional crown prosthetic treatment process.

FIG. 2 is a diagram illustrating an example of a device configuration for implementing the crown position setting method according to the present invention.

FIGS. 3A to 3D are diagrams for explaining a method of setting the position of a standard crown template in a teeth shape image according to an embodiment of the present invention.

FIG. 4 is a diagram for explaining a method of calculating the position of a working tooth in a teeth shape image according to an embodiment of the present invention.

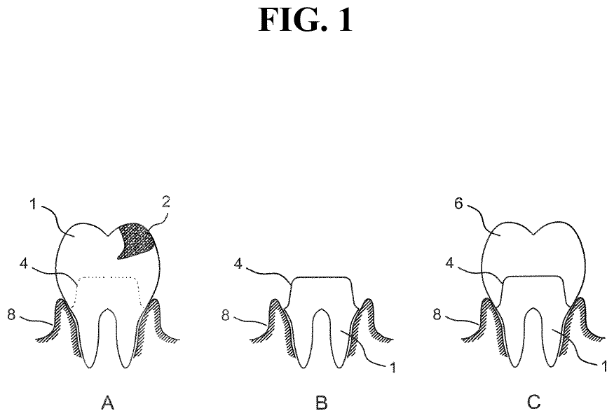

### DETAILED DESCRIPTION

Hereinafter, the present invention will be described in detail with reference to the accompanying drawings.

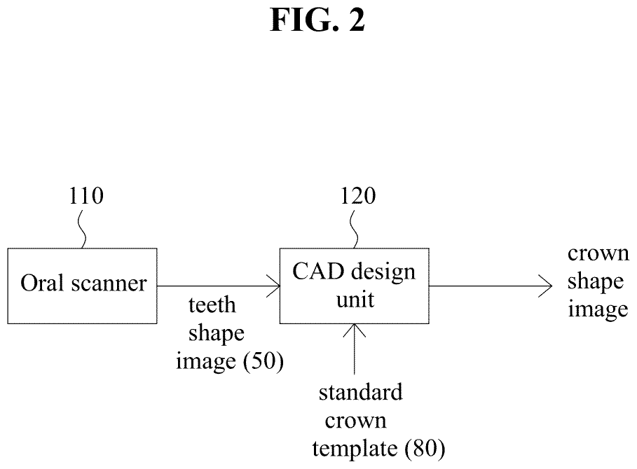

FIG. 2 is a diagram illustrating an example of a device configuration for implementing the crown position setting method according to the present invention. As shown in FIG. 2, according to the present invention, to set the position of a crown, first, a patient's oral cavity including a crown region where a tooth has been prepared is scanned using an oral scanner (110) or the like to generate a teeth shape image (50) including the crown region where the tooth has been prepared. The generated teeth shape image (50) is transmitted to a CAD design unit (120) and displayed on a monitor (not shown) of the CAD design unit (120). The CAD design unit (120), specifically, a software program of the CAD design unit (120), positions a standard crown template (80) on the transmitted teeth shape image (50), and then modifies the standard crown template (80) according to the teeth shape image (50) to design, i.e., to generate a crown shape image suitable for the patient's teeth shape.

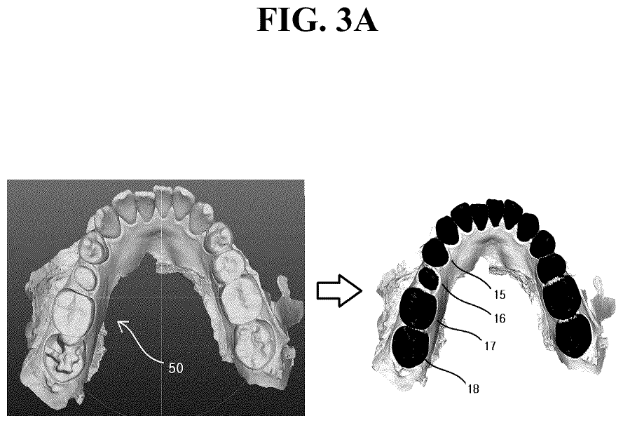

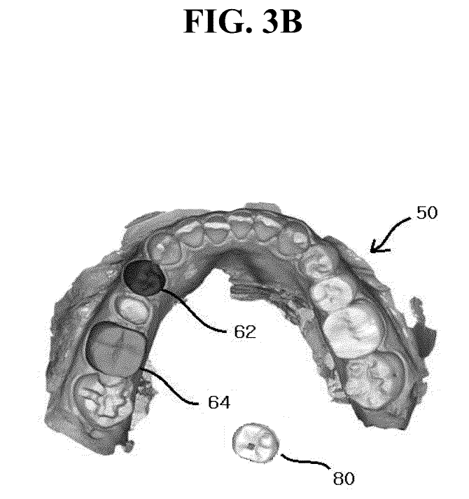

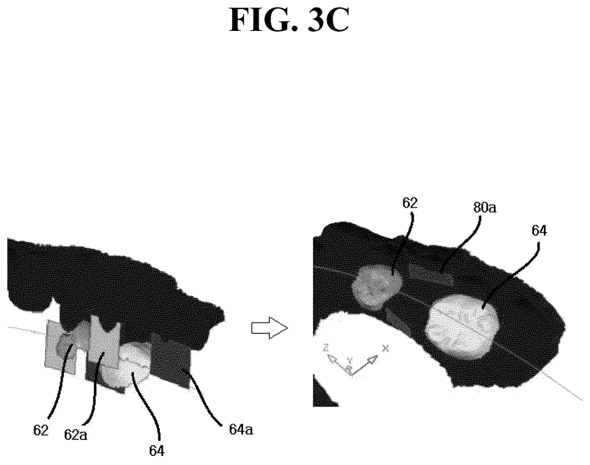

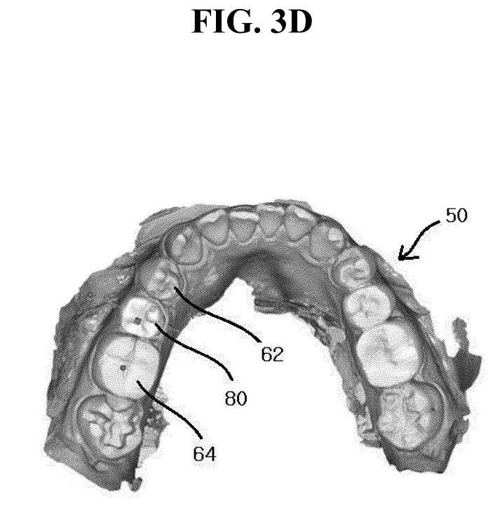

FIGS. 3A to 3D are diagrams for explaining a method of setting the position of a standard crown template in a teeth shape image according to an embodiment of the present invention. In FIGS. 3A to 3D, a maxillary arch tooth is shown as the teeth shape, but the present invention can be equally applied to a mandibular arch tooth.

First, as shown in FIG. 3A, the teeth shape image (50) is analyzed to segment the overall teeth shape into individual tooth regions (teeth segmentation). For example, the CAD design unit (120) loads work data transmitted from the oral scanner (110), i.e., the teeth shape image (50), and by an image analysis software mounted in the CAD design unit (120), individual tooth regions (18, 17, 16, 15), for example, fourteen (14) individual tooth regions, are segmented from the teeth shape image (50).

The teeth shape image (50) can be obtained using a commercialized program such as Dental 3D Mesh®, and the segmentation of individual tooth regions from the teeth shape image (50) can be implemented by an artificial intelligence software using deep learning.

Next, as shown in FIG. 3B, from the segmented individual tooth regions, a mesial tooth (62) and a distal tooth (64) respectively positioned anterior and posterior to the region (crown region) where the standard crown template (80), i.e., the working tooth (80), is to be positioned are selected.

In FIG. 3B, the mesial tooth (62) is shown in red, and the distal tooth (64) is shown in green. Since the tooth number (e.g., No. 16) of the working tooth (80) to be treated is already known, the teeth before and after the working tooth (80) (i.e., the teeth of No. 15 and No. 17) can be set as the mesial tooth (62) and the distal tooth (64), respectively.

Next, the position where the working tooth (80) is to be placed is calculated based on the positions of the mesial tooth (62) and the distal tooth (64).

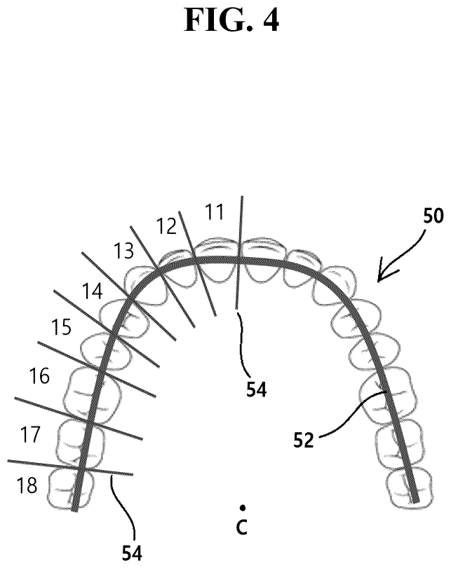

FIG. 4 is a diagram for explaining a method of calculating the position of a working tooth in a teeth shape image (50) generated by an oral scanner (110) according to an embodiment of the present invention. As shown in FIG. 4, for example, in a three-dimensional coordinate system of x, y, z, the center point coordinate c of the teeth shape image (50) is (0, 0, 0), and the teeth shape image (50) may consist of 129 coordinate points. For example, since the maxillary teeth include a total of 16 teeth, 8 coordinate points for each tooth and one center point may be assigned.

From the teeth shape image (50) generated in this way, position indices (i.e., position coordinates) for each tooth (18, 17, 16, 15, etc.) are calculated by the CAD design unit (120), and if necessary, rotation angles (directions in which the teeth are positioned) can be further calculated. For example, the position index of tooth No. 18 is 0, the position index of tooth No. 17 is 8, the position index of tooth No. 16 is 17, the position index of tooth No. 15 is 26, and the like, and the rotation angle of the tooth (direction in which the tooth is positioned) can be calculated from the directions of lines (54) perpendicular to a center line (52) connecting the center points of each tooth. For example, in FIG. 4, the rotation angle of tooth No. 18 is approximately 5 degrees, and the rotation angle of tooth No. 11 is approximately 90 degrees.

As shown in FIG. 4, since position indices (i.e., position coordinates) can be calculated for each tooth, using the calculated positions of the mesial tooth (62) and the distal tooth (64), the position where the working tooth (80) is to be placed (index of the working tooth (80)), i.e., the position of the crown region where the tooth has been prepared, can be calculated.

Next, if necessary, as shown in FIG. 3C, a region of the working tooth (80a) is calculated based on a region of the mesial tooth (62a) and a region of the distal tooth (64a). The region of the mesial tooth (62a) and the region of the distal tooth (64a) refer to spaces where the mesial tooth (62) and the distal tooth (64) are respectively positioned, i.e., bounding boxes. A region of the working tooth (80a), i.e., a space (i.e., bounding box) where the working tooth (80) is positioned, is set to be located between the region of the mesial tooth (62a) and the region of the distal tooth (64a). Here, the region of the working tooth (80a) is the tooth preparation area and also corresponds to the area where the crown is to be positioned.

Next, if necessary, using the region of the working tooth (80a), the size of the standard crown template (80), i.e., the working tooth (80), to be positioned in the crown region of the teeth shape image (50), can be calculated. The crown region of the teeth shape image (50) is the region where the working tooth (80) is to be placed.

Next, as shown in FIG. 3D, the working tooth (80) is positioned in the crown region of the teeth shape image (50) according to the calculated position where the working tooth (80) is to be placed. At this time, the size of the standard crown template (80), i.e., the working tooth (80), can be adjusted according to the size of the region of the working tooth (80a) where the working tooth (80) is to be placed, and the working tooth (80) can be positioned in the crown region of the teeth shape image (50).

In this way, after automatically positioning the standard crown template, i.e., the working tooth (80) in the correct position and direction in the region (crown region) where the working tooth (80) is to be positioned on the teeth shape image (50), the user modifies the standard crown template (80) using the CAD design unit (120) to generate a crown shape image suitable for the patient's tooth shape. That is, once the position of the standard crown template (80), i.e., the working tooth (80), is determined in the teeth shape image (50), CAD work for obtaining the crown shape is performed by the user by using a commercialized program such as Dental 3D Mesh.

Conventionally, a user checks the maxillary or mandibular model and manually moves the standard crown template (80), i.e., the working tooth (80), to the tooth preparation area of the maxillary or mandibular model (50). In contrast, in the present invention, the image analysis software of the CAD design unit (120) segments individual tooth regions from the teeth shape image (50), calculates the position of the working tooth (80) based on the positions of the mesial tooth (62) and the distal tooth (64), and can correctly position the standard crown template (80) in the tooth preparation area. Therefore, the present invention can improve user convenience.

In addition, the present invention can shorten the work time required for manufacturing prosthetics such as crowns and increase user convenience by calculating the region of the working tooth (80a) based on the region of the mesial tooth (62a) and the region of the distal tooth (64a).

Although the present invention has been described with reference to the accompanying drawings and exemplary embodiments, the present invention is not limited to the contents shown in the drawings and the above-described embodiments, and should be interpreted to encompass all modifications, equivalent configurations, and functions of the exemplary embodiments. In addition, reference numerals are indicated in the following claims for better understanding, but the scope of the following claims is not limited to the reference numerals and the contents shown in the drawings.

What is claimed is:

1. A crown position setting method comprising:
analyzing a teeth shape image including a crown region where a tooth has been prepared, to segment an overall teeth shape into individual tooth regions;
selecting, from the segmented individual tooth regions, a mesial tooth and a distal tooth respectively positioned anterior and posterior to the crown region where a working tooth is to be positioned;
calculating a position where the working tooth is to be placed based on positions of the mesial tooth and the distal tooth; and
positioning the working tooth in the crown region of the teeth shape image according to the calculated position where the working tooth is to be placed.

2. The crown position setting method of claim 1, further comprising:
calculating a region of the working tooth based on a region of the mesial tooth and a region of the distal tooth which are spaces where the mesial tooth and the distal tooth are respectively positioned; and
calculating a size of the working tooth to be positioned in the crown region of the teeth shape image using the region of the working tooth.

3. The crown position setting method of claim 2, wherein the size of the working tooth is adjusted according to a size of the region of the working tooth where the working tooth is to be placed, and the working tooth is positioned in the crown region of the teeth shape image.

4. The crown position setting method of claim 1, wherein the segmentation of individual tooth regions from the teeth shape image is performed by an artificial intelligence software using deep learning.

5. The crown position setting method of claim 1, wherein said step of calculating the position where the working tooth is to be placed based on the positions of the mesial tooth and the distal tooth comprises:
calculating position coordinates for each tooth; and
calculating the position where the working tooth is to be placed from calculated positions of the mesial tooth and the distal tooth.
